(19) United States
(12) Patent Application Publication
(10) Pub. No.: US 2024/0191097 A1
(43) Pub. Date: Jun. 13, 2024

(54) INTERPENETRATED POLYMER NETWORK PRODUCED BY PLASMA

(71) Applicant: LUXEMBOURG INSTITUTE OF SCIENCE AND TECHNOLOGY (LIST), Esch-sur-Alzette (LU)

(72) Inventors: Edyta NIEMCZYK, Esch sur Alzette (LU); Robert QUINTANA, Esch sur Alzette (LU); Pierre VERGE, Esch sur Alzette (LU)

(73) Assignee: LUXEMBOURG INSTITUTE OF SCIENCE AND TECHNOLOGY (LIST), Esch-sur-Alzette (LU)

(21) Appl. No.: 18/554,599

(22) PCT Filed: Apr. 7, 2022
(86) PCT No.: PCT/EP2022/059236

§ 371 Date: Oct. 9, 2023

(30) Foreign Application Priority Data
Apr. 9, 2021 (LU) 500020

(51) Int. Cl. C09D 171/02; C08L 33/08; C08L 71/02; C09D 133/08

(52) U.S. Cl. CPC C09D 171/02; C08L 33/08; C08L 71/02; C09D 133/08

(57) ABSTRACT

The invention is directed to a process of producing an interpenetrated network of at least two polymers; comprising the following steps:
(a) preparing a mixture (10) comprising a first monomer and a second monomer;
(b) applying the mixture (10) on a substrate (6); and
(c) curing the first monomer and the second monomer so as to form the interpenetrated network;
characterized in that the first monomer is a vinyl or allyl monomer; the second monomer is a polymerizable cyclic monomer; and step (c) comprises using a plasma (12) so as to first cure the first monomer.

### TECHNICAL FIELD

The invention is directed to the field of production of polymer coatings on a substrate. More specifically, the invention is directed to coating of interpenetrated polymer networks on a substrate.

### BACKGROUND ART

An Interpenetrating Polymer Network (IPN) is a polymer comprising two or more networks which are at least partially interlaced on a polymer scale but not covalently bonded to each other. The network cannot be separated unless chemical bonds are broken. The two or more networks can be envisioned to be entangled in such a way that they are concatenated and cannot be pulled apart, but not bonded to each other by any chemical bond. A mixture of two or more pre-formed polymer networks is not an IPN.

Polymeric coatings comprising of interpenetrated polymer networks (IPN) are a promising approach to avoid the phase separation problems encountered when blending two immiscible polymers. Indeed, polymer chains, interlacing and cross-linking during their formation, provide unique combination of properties that differ from the simple sum of those of attributable to original polymers.

From the different pathways for their synthesis, a sequential process i.e. synthesis of a first network followed by the swelling of the monomers of second network and their polymerisation, is the most common approach. Alternatively, the in situ formation from mixtures of mono- and multifunctional monomers allows to tune, almost at will, the key parameters governing the properties of the networks as cross-link density and distance between cross-links. UV radiation curing is the most representative and efficient case of rapid synthesis of IPNs coatings at room temperature from solvent-free liquid mixtures of bifunctional monomers. However, one of its main drawbacks is the need for two different photo-initiators: usually one to trigger a radical cross-linking polymerisation and the other, a cationic-type one. Despite the capability of generating UV radiations at different wavelengths, only a very limited range is accessible to match with most common photo-initiators used to trigger the polymerisation. In addition, only few are suitable for biomaterials synthesis.

Prior art patent document published WO 2015/169864 A1 discloses a method for forming a polymer thin film on a substrate, consisting essentially in applying a mixture comprising a monomer on the substrate and thereafter applying a pulsed plasma to said mixture, where the pulsed plasma shows a duty cycle t_{ON}/(t_{ON}+t_{OFF}) which is less than 1%. The mixture can be liquid, gaseous or solid and can comprise a solvent. The produced short current discharge induces formation of free radicals that initiate the free radical polymerisation process. The low duty cycle limits a potentially negative impact of the plasma on the film chemistry.

### SUMMARY OF INVENTION

### Technical Problem

The invention has for technical problem to overcome at least one drawbacks of the above cited prior art. More specifically, the invention has for technical problem to provide a method for producing IPNs that is more versatile with regard to the interpenetrated polymers.

The invention is directed to a process of producing an interpenetrated network (IPN) of at least two polymers; comprising the following steps: (a) preparing a mixture comprising a first monomer and a second monomer; (b) applying the mixture on a substrate; and
(c) curing the first monomer and the second monomer so as to form the interpenetrated network;
wherein the first monomer is a vinyl or allyl monomer; the second monomer is a polymerizable cyclic monomer; and step (c) comprises using a plasma so as to first cure the first monomer.

The elaboration of an IPN requires of the fulfilment of very specific conditions such as non-cross reactions between the two or more forming networks.

According to the invention, a main element is that the mixture of monomers for the formation of IPNs, for example as a film, is derived from the independent polymerization of each of the considered monomers.

The plasma curing according to the invention of in particular layers, preferably liquid or viscous layers, is especially used for low vapour pressure monomers. This advantage is used to the in situ plasma curing of vinyl or allyl monomer (first monomer) in the presence of another monomer (second monomer) without interfering with the curing of the latter. By this process, films, preferably thin films, with IPN can be produced sequentially. Plasma deposition allows a high degree of the cross linking, fast curing and in situ polymerisation of liquid monomers mixture in a non-invasive manner. Advantageously, the plasma conditions may be selected to (i) avoid or to minimize the alteration of the chemical structure of the second monomer by the plasma radiation and/or (ii) not to induce its polymerisation.

Accordingly, a suitable range of the plasma power values (expressed in power by surface area—W·cm⁻²) is generally needed to prevent the reaction of the second monomer units during the formation of the first network by plasma exposure. To that end, plasma power values range may preferably be of from 0.1 to 150 W·cm⁻², more preferably of from 0.1 to 100 W·cm⁻², better of from 0.1 to 35 W·cm 2, especially of from 0.5 to 35 W·cm⁻². In some other embodiments, power values range may be of from 1 to 35 W·cm⁻². Said power values are the best suited for the formation of IPN by plasma-initiated polymerization in such a manner that the occurrence of cross-reactions is prevented and/or avoided.

The vinyl or allyl monomer may advantageously be poly-functional or a mixture of mono-functional and poly-functional monomers. The first monomer exhibits the ability of at least one double bound to undergo free radical polymerization. It may advantageously comprise a telechelic monomer or oligomer like ethylene glycol or polyethylene glycol, the latter may have molecular weights of from 200 g/mol to 20 000 g/mol, preferably of from 300 g/mol to 10 000 g/mol, more preferably of from 300 g/mol to 5 000 g/mol (n≥2 EG units, preferably n≥4 EG units). The vinyl or allyl monomer can be, in some embodiments, at least one selected from the group consisting of acrylate derivatives, acrylic, styrenic or vinyl ether and macromonomer derivatives thereof.

The plasma used in step c) can be continuous or pulsed, i.e. delivered with an electrical signal in a continuous or pulsed wave form.

According to a preferred embodiment, an electrical excitation may be used in step (c) for the generation of the plasma. In some embodiments, the electrical excitation may comprise an electrical signal having a frequency in the following ranges: from 1 to 500 KHz (low frequency) and from 0.1 to 2.45 GHz (Microwave). In some embodiments, the electrical excitation may comprise a radiofrequency signal, equalled to 13.56 MHz, 27.12 MHz, 40.68 MHz or 81.36 MHz. In some alternate embodiments, the radiofrequency signal may be comprised within the range of values of from 13 to 85 MHz.

According to a preferred embodiment, the plasma may be pulsed with a duty cycle t_{ON}/t_{ON}+t_{OFF}, where t_{ON} is a duration of the plasma when active and t_{OFF} is a duration of the plasma when inactive, during each cycle, that may preferably be comprised between 10⁻⁴ and 10⁻² μs. Within these conditions, activation and/or dissociation of the monomers and generation of active sites on the surface occurs during t_{ON} while along the t_{OFF}, polymerization can occur without the interference of charged species investing the sample.

According to a preferred embodiment, the plasma may be pulsed and may exhibit, for each cycle, an active duration t_{ON} that is not more than 0.2 ms and an inactive duration t_{OFF} that is more than 10 ms.

According to a preferred embodiment, the plasma may be at atmospheric pressure.

According to a preferred embodiment, the plasma may be a Dielectric Barrier Discharge plasma.

According to a preferred embodiment, the first monomer may preferably comprise a telechelic monomer or oligomer, or may preferably be at least one selected from the group consisting of methacrylate (MA) derivative, preferably ethylene glycol dimethacrylate (EGDMA) and/or polyethylene (PEGDMA), methylacrylate, ethylacrylate, 2-glycol dimethacrylate chloroethylvinylether, 2-ethylhexylacrylate, hydroxyethylmethacrylate, butylacrylate, butylmethacrylate, TMPTA, allyl acrylate and allyl methacrylate, or mixture thereof.

According to a preferred embodiment, the mixture may be free of an polymerisation initiator and/or reversible radical transfer agents. This provides a process using the necessary minimum of reactants. The process may then be carried out with the proviso that polymerisation initiator and/or reversible radical transfer agents are excluded from the mixture. Without being bound by any theory, the use of a reversible radical transfer agent, which controls the formation of the reactive free-radicals, may be the key to prevent cross-reactions between two monomers and therefore to allow the formation of an IPN structure.

According to the invention, the second monomer is a cyclic polymerizable monomer, containing cycles or rings which are polymerized by ring opening polymerization which can proceed via radical, anionic, or cationic polymerisation, and which does not interfere with free radical polymerization of vinyl or allyl monomers. Such second monomers may advantageously represent benzoxazines derivatives, epoxide derivatives, cyclic acetals, lactams and cyclosiloxanes telechelic monomers or oligomers.

According to a preferred embodiment, the second monomer may comprise benzoxazine (BZ or Bz). ROP of Bz induce cleavages into carbocations C—O bonds and phenoxide anions, which react with the ortho-positions of the Bz units (aminoalkylation of phenoxide anions) forming PBz networks constituted by ortho-substituted phenol linkages.

According to a preferred embodiment, the second monomer may be selected from the group consisting of a telechelic benzoxazine oligomer or monomer with a chemical backbone similar in nature to the one of the first monomer.

According to a preferred embodiment, the second monomer may be selected from the group consisting of a telechelic oligomer or monomer, a telechelic monomer of benzoxazine BZ and of ethylene glycol EG (BZ-EG-BZ) and a telechelic monomer of benzoxazine BZ and polyethylene glycol PEG (BZ-PEG-BZ). Preferably, the PEG may be as defined above.

According to a preferred embodiment, in the mixture (step a)), a ratio in weight between the first monomer and the second monomer may be of from 80/20 to 40/60, preferably between 70/30 and 50/50. Alternately, when the first monomer is associated with ethylene oxide backbone originating from EG, said ratio may preferably be of from 70/30 to 50/50, better of from 70/30 to 45/55.

According to a preferred embodiment, in step (c) the plasma used for first curing the first monomer may be followed by a thermal curing of the second monomer.

According to a preferred embodiment, the thermal curing may be achieved at a temperature comprised between 170° C. and 210° C. The thermal curing may be performed using conventional heating means, such as a convection oven.

According to a preferred embodiment, the thermal curing may have a duration of at least one hour, preferably from 1 h to 4 h.

According to a preferred embodiment, steps (b) and (c) may be performed iteratively in such a manner that the step (c) is limited to the plasma curing of the first monomer until obtaining a predetermined thickness of a corresponding layer, preferably from 10 nm to 5 μm, after that the thermal curing of the second monomer is carried out.

According to some other embodiments, steps (b) and (c) may be carried out iteratively where a thickness of a layer, preferably of from 10 nm to 5 μm, that may be obtained in step (b) and/or curing parameters in step (c) are varied between iterations in order to achieve a crosslinking gradient in a direction normal to the substrate.

The substrate used in step b) may preferably be organic or inorganic, with the proviso that the substrate is suitable for the implementation of the process, for example in terms of temperature.

In some embodiments, a suitable inorganic substrate may be or a metal substrate, for example a nickel, titanium, steel, stainless steel or aluminium substrate or a ceramic substrate, for example a glass or silicon wafer. A suitable organic substrate may be a polymeric substrate, for example nylon, polyamide, polyurethane, polyester, polytetrafluoroethylene, polystyrene, polypropylene, polyethylene substrate.

A layer, that may be formed in step b), may be obtained by any known means, for example using classical manual means, nebulizer/spraying systems or by a spin coater. The thickness of the deposited layer on the substrate may be preferably of from 20 nm to 5 μm.

The invention is also directed to an interpenetrated network of at least two polymers applied on a substrate, wherein the at least two polymers comprise a first polymer that is a vinyl or allyl polymer and a second polymer obtained through the curing of a polymerizable cyclic monomer.

According to a preferred embodiment, the first polymer may be derived from the first monomer as above mentioned.

The second polymer may be obtained through Ring-Opening Polymerisation (ROP) of the polymerizable cyclic monomer mentioned above, and may advantageously be a polymer of benzoxazine BZ and of ethylene glycol EG (BZ-EG-BZ), or a polymer of benzoxazine BZ and polyethylene glycol PEG (BZ-PEG-BZ).

According to a preferred embodiment, a ratio in weight between first polymer and second polymer may be comprised between 80/20 and 40/60, preferably between 70/30 and 50/50.

### Advantages of the Invention

The invention is particularly interesting in that it provides a method for in-situ sequential synthesis of IPNs that does not require the use of chemical initiators like a photo-initiator for UV curing, and/or reversible radical transfer agents. The method of the invention can therefore be carried out without chemical initiator. It should be noted that the method of the invention may also be carried out using chemical initiators, still showing the advantage that chemical initiators of lower activity and/or in lower concentrations can be selected. This alternative is however less preferred.

The resulting IPNs are advantageous in that they show improved mechanical and thermal characteristics. The thermal stability and char yields of the IPNs frameworks are increased in a synergistic manner due to the addition of the second monomer to the first polymer obtained through the step c), followed by a curing step of the second monomer. The thermal stability may for example be increased of from 2% to 5% when the weight of the second monomer in the weight ratio between first and second polymers is higher than 20, preferably higher than 30, more preferably of from 30 to 60, better of from 30 to 50. Such weight ratios may then be of from 80/20 to 40/60.

When the first monomer is associated with ethylene oxide backbone originating from EG and/or PEG, the char yield increases with shortening of the ethylene oxide backbone and increasing concentration of the second monomer. The char yield increase may be then of from 100% to 300%. By adapting the weight ratio between the first and second monomers, the resulting IPNs may be tailored to increase the thermal stability and char yield.

Alternately, the first monomer and/or the second monomer may be associated with EG and/or with an polymer or oligomer like poly(ethylene) glycol PEG where the length of the ethylene oxide backbone may be tailored by selecting the molecular weight of the starting EG and/or PEG polymer or oligomer. In such a case, the Young modulus as a mechanical property of the IPNs is decreased with the decrease of the weight of the second monomer in the mixture intended to be cured. This is observed for example with the decrease of the weight of the second polymer in the mixture, such as the weight ratio defined above may vary from 70/30 to 50/50.

### BRIEF DESCRIPTION OF THE DRAWINGS

FIG. 1 is a schematic illustration of the main steps of the process of producing an IPN according to the invention.

FIG. 2 is a schematic representation of the successive polymerisation of two polymers so as to form an IPN according to the invention.

FIG. 3 is a graphic representation of the heat flow of an IPN according to example 1 of the invention, during the second, ring opening, polymerisation.

FIG. 4 is a graphic representation of the heat flow of an IPN according to example 2 of the invention, during the second, ring opening, polymerisation.

FIG. 5 is a graphic representation of the heat flow of an IPN according to example 3 of the invention, during the second, ring opening, polymerisation.

FIG. 6 is a graphic representation of the heat flow of an IPN according to example 4 of the invention, during the second, ring opening, polymerisation.

FIG. 7 is a graphic representation of the absorbance, by Fourier-transform infrared spectroscopy, of an IPN according to example 1 of the invention, before plasma curing, after plasma curing and after thermal curing.

FIG. 8 is a graphic representation of the absorbance, by Fourier-transform infrared spectroscopy, of an IPN according to example 2 of the invention, before plasma curing, after plasma curing and after thermal curing.

FIG. 9 is a graphic representation of the absorbance, by Fourier-transform infrared spectroscopy, of an IPN according to example 3 of the invention, before plasma curing, after plasma curing and after thermal curing.

FIG. 10 is a graphic representation of the absorbance, by Fourier-transform infrared spectroscopy, of an IPN according to example 4 of the invention, before plasma curing, after plasma curing and after thermal curing.

FIG. 11 is a graphic representation of the scratch resistance of IPNs according to example 4 of the invention, after plasma curing and after thermal curing: Table 1 entry 3.2 and 4.1, FIGS. 11a and 11b, respectively, compared with a non-IPN sample prepared by plasma curing of the first monomer, without the presence of the second monomer (FIG. 11c, polyPEGDMA).

### DESCRIPTION OF AN EMBODIMENT

The invention is primarily directed to a method of producing an IPN and also to the resulting IPN. Both aspects of the invention will be described in connection with the figures and tables, being understood that the embodiments that will be described are merely illustrative and that other embodiments are possible.

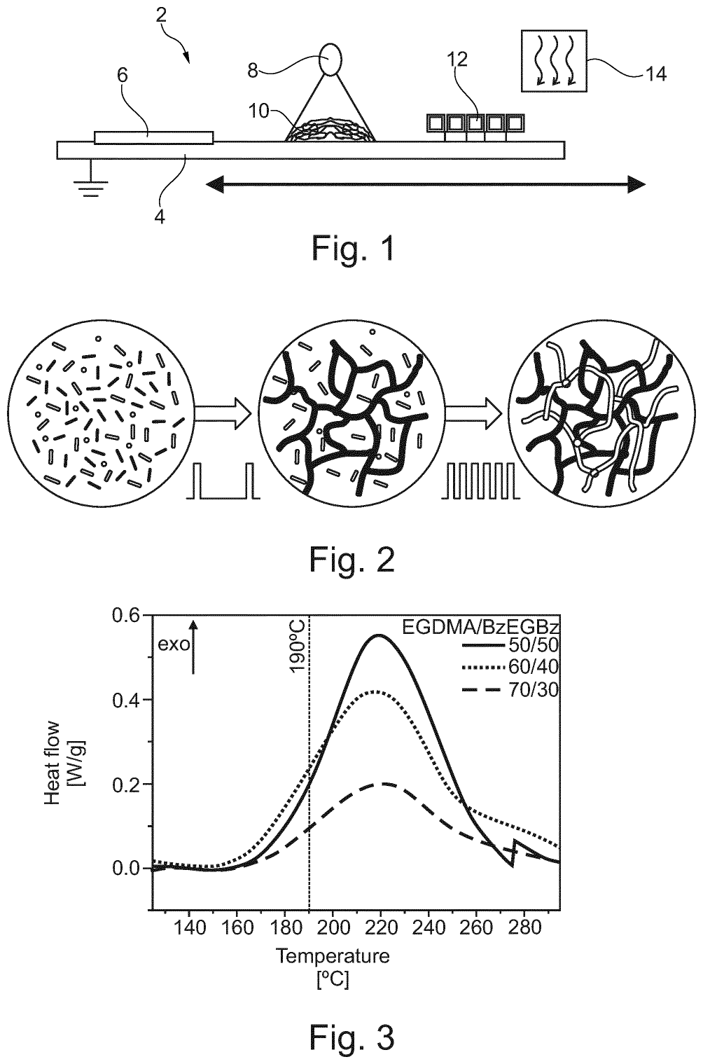

FIG. 1 illustrates in a schematic way an installation for producing an IPN on a substrate, according to the invention. The installation 2 comprises essentially a moving table 4, forming for instance a grounded electrode, for carrying a substrate 6 to be coated. The installation 2 further comprises a deposition unit 8 for applying a liquid mixture 10 on the substrate 6, in particular on an upper face of the substrate 6. The deposition unit 8 can be a spin coater or a spaying unit with atomizing nozzles as illustrated. The installation 2 further comprises a plasma reactor 12 which can be of the Dielectric Barrier Discharge DBD type. The plasma reactor 12 is advantageously at room temperature and/or atmospheric pressure. The installation 2 can further comprise a heating unit 14 for thermally curing the mixture applied on the substrate 6. The heating unit 14 is advantageously a convection oven.

The process of producing an IPN consists essentially in preparing a mixture comprising a first monomer and a second monomer, to apply that mixture on the substrate 6 placed on the moving table 4 of the installation 2, by means of deposition unit 8, to proceed to a polymerisation of the first monomer by means of the plasma reactor 12 and thereafter to proceed to a polymerisation of the second monomer by means of the plasma reactor 12 and/or the heating unit 14. The moving table 4 can move in a reciprocal manner so that the substrate 6 coated with the mixture can pass several times through the plasma reactor 12 for successive plasma treatments, possibly with different operational parameters such as voltage, current, and/or signal type (pulsed, alternating like sinusoidal, etc.). The reciprocal movements of the moving table 4 can move the substrate 6 back to the deposition unit 8 for applying a further layer or coating of the mixture. This is particularly advantageous in that it allows forming a coating layer of IPN with a gradient in crosslinking in a direction normal to the upper face of the substrate 6. All means of the installation as depicted in FIG. 1 are known to the one skilled in the art and are not the crux of the invention.

FIG. 2 illustrates in a schematic way the successive polymerisation of two monomers so as to form an IPN according to the invention.

The left image shows the first and second monomers mixed together in the mixture to be applied to the substrate. The first monomers are represented by solid dashes whereas the second monomers are represented by hollow dashes. Both monomers are mixed homogeneously in the mixture, possibly with one or several appropriate solvents. The solvent(s) may be used in a quantity just necessary to obtain a homogeneous mixture of both monomers. Examples of solvents may include chlorinated alkanes, such as chloroform or methylene chloride, aromatic solvents, such as toluol, or a heterocyclic compound, such as tetrahydrofurane (THF) or dimethylsulfoxide (DMSO). The solvents may be omitted where at least one considered monomer or both monomers are in liquid state at room temperature allowing the achievement of the homogeneous mixture. In some embodiments, to obtain said homogeneous mixture, both polymers may be slightly heated to a temperature not causing the degradation of each monomer.

The mixture applied on the substrate is then subject to a plasma treatment achieving a first polymerisation, i.e. a polymerisation of the first monomers. This plasma treatment can be a pulsed plasma with a low duty ratio t_{ON}/(t_{OFF}+t_{ON}) where t_{ON} is a duration of the plasma when active and t_{OFF} is a duration of the plasma when inactive, i.e. of less than 1%. The pulse duration t_{ON} is advantageously less than 10⁻³ μs. The first polymerisation is a free radical reaction.

The central image shows the polymerised state of the first monomers while the second monomers are still not polymerised.

The mixture partly polymerized on the substrate is then subject to a further curing treatment achieving a second polymerisation, i.e. a polymerisation of the second monomers. This curing treatment can be a thermal treatment as with the heating unit 14 in FIG. 1 or a plasma treatment, e.g. with a higher duty ratio as for the first polymerisation. The second polymerisation is a ring-opening polymerisation of the second monomers which are cyclic. The reactive centres in the ring-opening polymerisation are advantageously ionic, generated by the more energetic second curing treatment.

The right image shows the polymerised state of both first monomers and second monomers in an interpenetrated state.

The first monomer is a vinyl or allyl, for the inventors have observed that exposure of vinyl or allyl monomers to plasma, in particular pulsed plasma, produces radicals and neutral fragments that play the role of polymerisation initiation and termination groups. The inventors have also observed that this fast formation enables to form a further network, for instance interpenetrated, by applying a further curing step, i.e. plasma and/or heat based. The vinyl polymer advantageously comprises methacrylate MA units.

The second monomer is a cyclic monomer which can undergo a Ring-Opening Polymerisation (ROP). Ring-opening polymerisation can proceed via radical, anionic, or cationic polymerisation. Advantageously, the second monomer is or at least comprises benzoxazine BZ.

### EXPERIMENTAL RESULTS

### Monomers

3-(4-Hydroxyphenyl)propionic acid (98 wt %, phloretic acid, PA), furfurylamine (≥99 wt %, FU), polyethylene glycol (average Mn 400, PEG400, n=8 EG units), ethylene glycol (EG), paraformaldehyde (PFA) and p-toluene sulfonic acid monohydrate (≥98.5%, TsOH), ethylene glycol dimethacrylate (98% EGDMA) were purchased from Sigma-Aldrich Chemicals and were used as received without any purification. Silicon wafer substrates (thickness 725±25 μm, P/B, 1-30 Ohm-cm) were cut out and cleaned in an ultrasonic bath first with Decon90 2% vol solution for 5 min, followed by technical grade acetone (3 times, 5 minutes each) and absolute ethanol (3 times, 5 minutes each). When necessary, other types of substrates were cleaned in same manner.

### Synthesis of Benzoxazine Telechelic PEG

Benzoxazine telechelic poly(ethylene oxide) was synthesized where ethylene glycol (or PEG400) esterification with phloretic acid, catalyzed by p-toluene sulfonic acid, was carried out in a glass flask at room temperature in bulk. Without intermediate purification, to the phenol terminated reaction product (PA-EG-PA or PA-PEG-PA) was added stoichiometric furfurylamine and paraformaldehyde was left to react at 70° C. for 72 h. The successful synthesis of benzoxazines BZ-EG-BZ and BZ-PEG-BZ was confirmed by Fourier-transform infrared spectroscopy FT-IR and Nuclear Magnetic Resonance NMR analyses.

Several series of mixtures of methacrylate (MA) monomers, for instance EGDMA and PEGDMA, and benzoxazine (Bz) monomers, for instance BzEGBz and BzPEGBz were prepared according to the following Table 1.

TABLE 1

| | | DMA/Bz |
|---|---|---|
| # | Monomers | in weight |
| 1.1 | EGDMA/BzEGBz | 50/50 |
| 1.2 | | 60/40 |
| 1.3 | | 70/30 |
| 2.1 | EGDMA/BzPEGBz | 50/50 |
| 2.2 | | 60/40 |
| 2.3 | | 70/30 |
| 3.1 | PEGDMA/BzEGBz | 50/50 |
| 3.2 | | 60/40 |
| 3.3 | | 70/30 |
| 4.1 | PEGDMA/BzPEGBz | 50/50 |
| 4.2 | | 60/40 |
| 4.3 | | 70/30 |

### Process

Thin liquid layers from the mixture of monomers (10 μl) were deposited over silicon substrates by using a spin coater (Laurell Technologies, WS-650-23B) operating at 10 000 rpm for 30 seconds. The thin liquid layer was then polymerized using an atmospheric pressure Dielectric Barrier Discharge (DBD) plasma reactor. The plasma was generated between two parallel and horizontal electrodes, with an active plasma zone of 18.72 cm², connected to a SOFTAL 7010R corona generator providing a 10 kHz sinusoidal electrical excitation and 30 W· power (i.e. 1.6 W·cm⁻²). The top electrode was formed by two high voltage (HV) bars, covered with thick alumina-dielectric barrier material, separated by a third bar used to introduce the plasma gas (Argon, 20 slm). The grounded electrode is a moving table where the silicon substrates covered by the spin-coated layer were placed. The samples were exposed to the argon plasma three times at the table speed of 1 mm/s to polymerize the methacrylate telechelic molecules. Afterwards, the samples were placed in a convection oven at 190° C. for 2 hours for thermally curing of the benzoxazine telechelic monomers.

In another embodiment, a so-called dynamic process was followed which is characterized by an iteration between the deposition of a liquid layer over the substrate, by means of a nebulization system, and the plasma curing of such a layer, in such a manner that the thickness of the layer increases after each iteration. The process took place at a higher table speed of 100 mm/s and the number of iterations spanned from 1 to 400. Afterwards, the samples were placed in a convection oven at 190° C. for 2 hours for thermally curing of the benzoxazine telechelic monomers.

Thermal Curing of the Benzoxazine Embedded in the Plasma Polymerized Methacrylate Network

The ROP of Bz within the IPN thin films was studied by Differential Scanning calorimetry DSC and Thermo-gravimetric analysis TGA. DSC thermograms were recorded by means of a Netzsch DSC 204 F1 Phoenix apparatus operating under inert atmosphere (nitrogen) with a 3-run non-isothermal program (heating, cooling and heating) from 25 to 300° ° C. at 20° C.·min⁻¹ rate. TGA was performed on a Netzsch TG 409 PC Luxx device operating under nitrogen flow with heating ramp from room temperature to 800° ° C. at 20° C.·min⁻¹ rate.

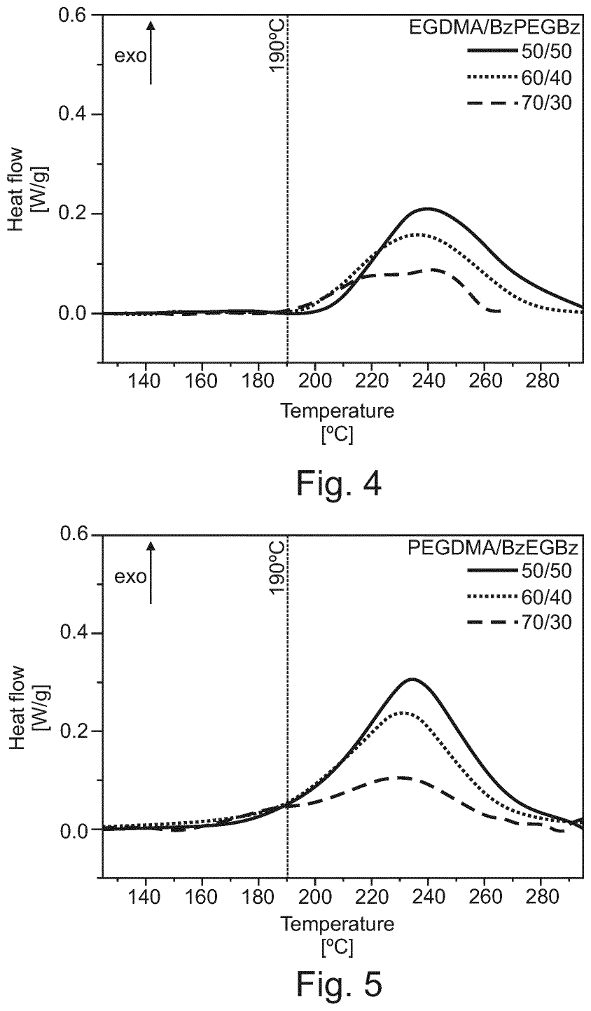

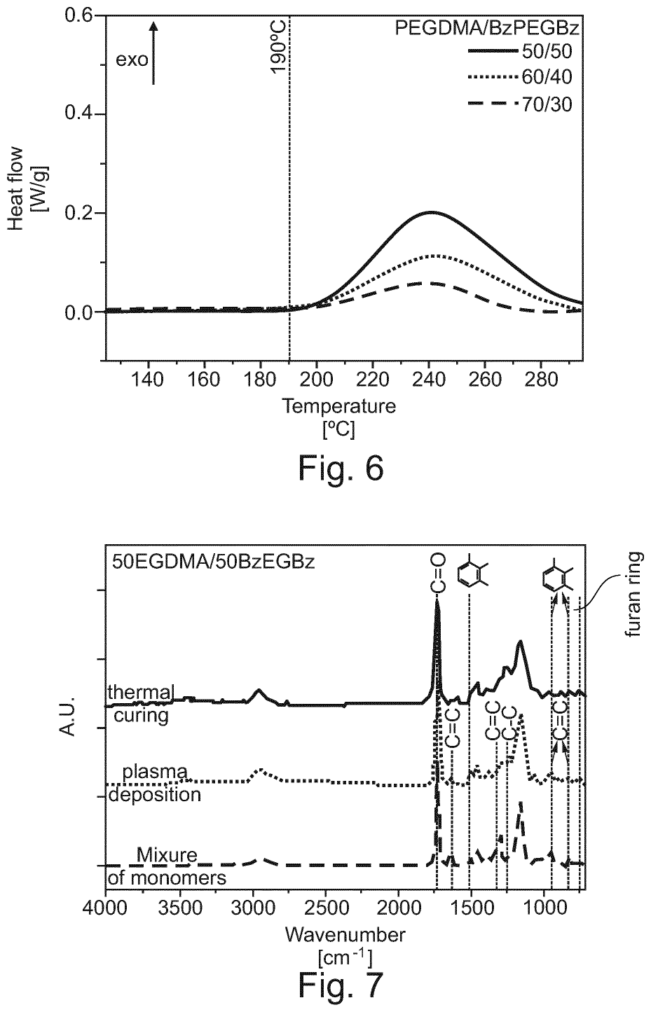

FIGS. 3 to 5 show DSC thermograms of IPNs combining Bz with MA with various ratios according to Table 1. The DSC investigation suggests that ROP mechanism starts already at 174 and 178.8° C. for BzEGBz and BzPEGBz, respectively. The thermograms show curves of heat flux versus temperature. As per convention exothermic reactions in the sample are shown with a positive peak. These curves can be used to calculate enthalpies of transitions. This is done by integrating the peak heat flow corresponding to a given transition. It can be shown that the enthalpy of transition can be expressed using the following equation: ΔH=K·A where ΔH is the enthalpy of transition, K is the calorimetric constant, and A is the area under the curve. The calorimetric constant will vary from instrument to instrument and can be determined by analysing a well-characterized sample with known enthalpies of transition.

The temperatures Tₒₙ₋ₛₑₜ at which the ROP starts, the temperatures Tₚₑₐₖ at which the heat flow is maximum and the calculated ROP enthalpies are provided in Table 2. Normalized rates of ROP have been calculated and are also provided in Table 2. The normalization of ROP rates was performed by calculating a ratio between the ROP enthalpy in IPNs and ROP enthalpy of the reference Bz, i.e. neat Bz oligomer, which was given the value of 1. Then, each ratio was determined by multiplication of the percentage of Bzs concentration in IPNs by the reference at 100% ROP yield. This allows to determine some trends, for instance, that increasing the ethylene oxide backbone length causes a decrease of ROP yield. The trends can be followed in Table 2 for each composition, namely drop of Tₒₙ₋ₛₑₜ and ROP enthalpy due to the dilution of Bz in IPNs, and between compositions overall it was evidenced a decrease of normalized ROP value.

In the above DSC, it has to be considered that ROP was performed with a heating rate 20° C./min (around 5 minutes), which does not necessarily allow a complete curing. This does not however weaken the comparative value of the above study.

TGA studies have also revealed that the degradation of BzEGBz occur already at 160° C.

Considering the thermal characteristics of both Bz oligomers, and their performance in presence of DMA network, it was chosen to perform the thermal curing at 190° C.

TABLE 2

| | | | | | ROP | ROP |
|---|---|---|---|---|---|---|
| | | DMA/Bz | Tₒₙ₋ₛₑₜ | Tₚₑₐₖ | enthalpy | normalized |
| # | Monomers | in wt | ° C. | ° C. | mW/mg | % |
| | BzEGBz | — | 174 | 220 | 79.16 ± | 100 |
| | BzPEGBz | | | | 4.11 | |
| | | — | 178 | 233 | 41.99 ± | 100 |
| | | | | | 3.09 | |
| 1.1 | EGDMA/ | 50/50 | 175 | 219 | 40.67 ± | 102.75 |
| | BzEGBz | | | | 2.57 | |
| 1.2 | | 60/40 | 163 | 217 | 28.89 ± | 91.24 |
| | | | | | 4.71 | |
| 1.3 | | 70/30 | 170 | 221 | 19.72 ± | 83.04 |
| | | | | | 1.74 | |
| 2.1 | EGDMA/ | 50/50 | 205 | 242 | 13.71 ± | 65.31 |
| | BzPEGBz | | | | 0.62 | |
| 2.2 | | 60/40 | 199 | 236 | 10.57 ± | 62.95 |
| | | | | | 0.52 | |
| 2.3 | | 70/30 | 197 | 241 | 4.01 ± | 31.85 |
| | | | | | 0.32 | |
| 3.1 | PEGDMA/ | 50/50 | 193 | 235 | 17.40 ± | 43.97 |
| | BZEGBz | | | | 1.13 | |
| 3.2 | | 60/40 | 186 | 231 | 12.36 ± | 39.02 |
| | | | | | 0.88 | |
| 3.3 | | 70/30 | 163 | 229 | 8.19 ± | 34.49 |
| | | | | | 0.24 | |
| 4.1 | PEGDMA/ | 50/50 | 203 | 241 | 10.80 ± | 51.45 |
| | BzPEGBz | | | | 0.86 | |
| 4.2 | | 60/40 | 198 | 244 | 7.63 ± | 45.40 |
| | | | | | 1.14 | |
| 4.3 | | 70/30 | 200 | 241 | 3.21 ± | 25.50 |
| | | | | | 0.79 | |

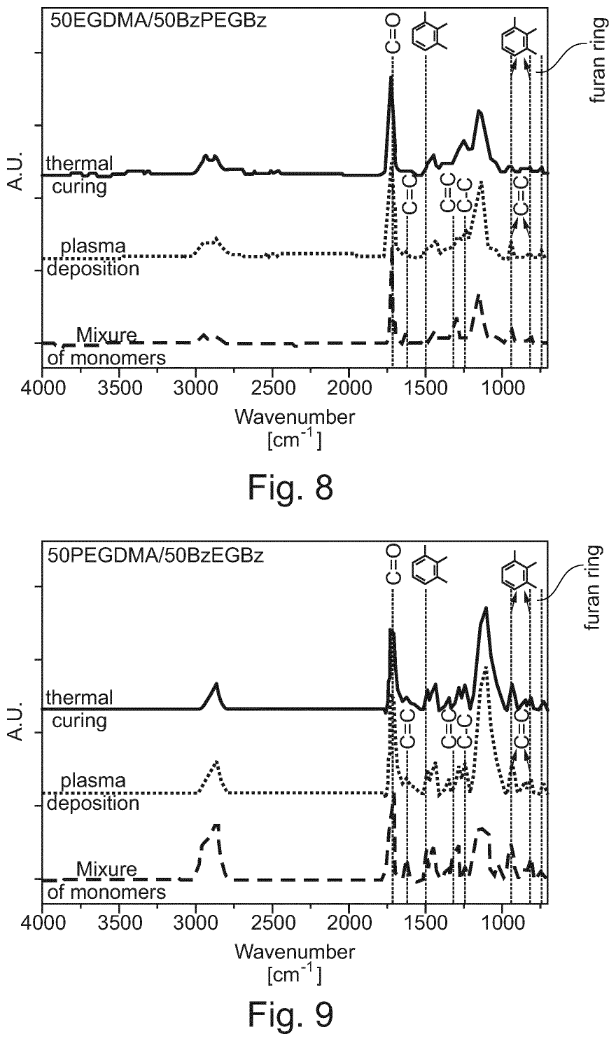

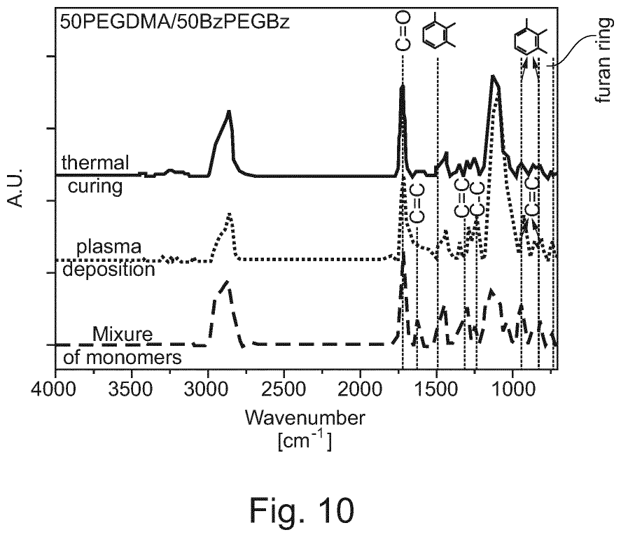

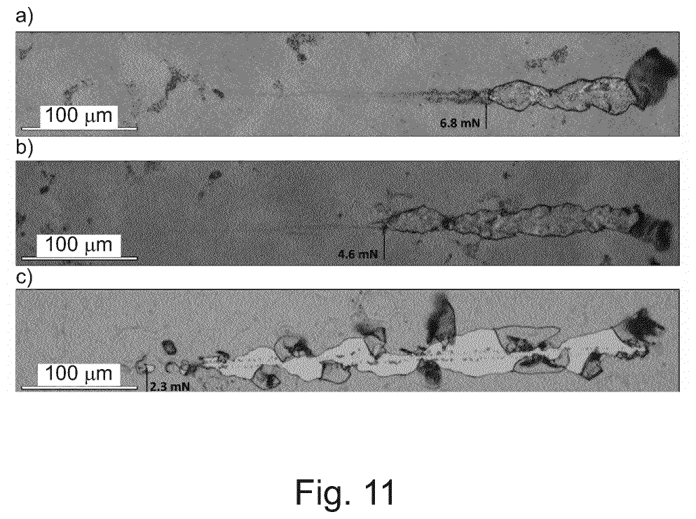

FIGS. 7 to 10 show structural characterisations by absorbance units (A.U.) in Fourier-transform infrared spectroscopy FT-IR of the above examples (at DMA/Bz ratios of 50/50 only) before, during and after polymerisation for wavenumbers ranging from 4000 to 900 cm⁻¹.

Samples of the examples in Tables 1 and 2 were taken before curing, after plasma treatment and after thermal curing. FT-IR transmission measurements were performed on a Bruker Vertex 70 spectrometer (Ettlingen, Germany) and measured with a Mercury cadmium telluride MCT detector. All FT-IR data were normalized according to the C═O stretching band measured at 1730 cm⁻¹ as it should be less altered by this level of plasma discharge energy and is unaffected by cross-linking reactions.

For each of FIGS. 7 to 10, in the lower curve relating to the mixture of monomers, i.e. prior curing by plasma treatment and for instance thermal treatment, characteristic bands for DMA can be observed at 1637 cm⁻¹, 1310 cm⁻¹ (C═C stretching) and 810 cm 1 (C—H stretching) and are assigned to present in monomer vinyl group. In the intermediate curve relating to the mixture of monomers after plasma treatment, we can observe a drop of each of these peaks as well as a shift of the peak at 1830 cm⁻¹ (C═O) to lower values and also appearance of a C—C stretching band at 1250 cm⁻¹. This implies a successful formation of polyDMA network. Vinyl groups enable DMA's efficient polymerisation by plasma deposition, following the radical mechanism. Plasma deposition allows a high degree of the cross linking, fast curing and in-situ polymerisation of liquid monomers mixture in a non-invasive manner.

Still for each of FIGS. 7 to 10, in the higher curve relating to the mixture of monomer after thermal treatment, we can observe a decrease of intensity at 1229 cm⁻¹ (stretching C—O—C), 750 cm⁻¹ (vibration of monosubstituted furan ring), 850 cm 1 (out-of-plane wagging), 1493 cm⁻¹ and 942 cm⁻¹ (trisubstituted benzene ring), confirming Bz transformation from an end-capped telechelic ring to the network structure. ROP of Bz induce cleaves into carbocations C—O bonds and phenoxide anions, which react with the ortho-positions of the Bz units (aminoalkylation of phenoxide anions) forming PBz networks constituted by ortho-substituted phenol linkages.

To have an insight into chemical composition of IPN thin films, XPS analysis was performed, as complementary data source to FT-IR. For technical reasons only samples synthesized from 60/40 wt % ratio of DMA/Bz were analysed. The range has been chosen as it represents intermediate concentration composition for set of investigated samples with good homogeneity examined by naked eye. X-ray photoelectron spectroscopy XPS measurements were performed on a Kratos Axis-Ultra DLD instrument, using an Al Kα source (1486.6 eV) with a pass energy of 20 eV and an energy resolution of 0.5 eV. A flooding gun was used to reduce charging effect on the samples surface.

The results of the above analysis are in Table 3 showing values for the concentrations in C, O, N and the C/O ratio for neat DMA and Bz components as well as for the four examples 1.2, 2.2, 3.2 and 4.2 of tables 1 and 2. Theoretical calculated values are provided in brackets ([-]).

XPS survey spectra for neat DMA components (EGDMA and PEGDMA) show minor differences of atomic percentage in comparison with theoretical calculations due to the fact that polyEGDMA and polyPEGDMA thin films reveal slight amount of nitrogen. The nitrogen presence in the polyDMA thin films is a result of the atmospheric nitrogen absorption to coating from the air and its participation in polymerisation process. Additionally, despite the thin film was deposited in the argon atmosphere, between scans sample was exposed to ambient air. Therefore the access to the nitrogen while preparing and processing samples cannot be neglected, and might influence chemical composition of coatings. Nevertheless, comparing the C/O ratio of polyEGDMA and polyPEGDMA show higher values than theoretically calculated. Plasma as high energetic medium might influence scissions of ester groups and its depolymerisation. The differences in coatings compositions for Bzs very likely comes from its synthesis. Bz can be mono- or di-substituted. The values given in Table 3 are for ideal di-substitution of benzene ring.

The theoretical calculations of IPNs content are based on values measured for neat oligomers structures according to concentration ratio applied, while preparation. The calculations do not show significant differences from the measured data, which indicate formation of the two independent frameworks without cross-reactions. The differences come from the fact of standard DMA evaporation (while spin coating and movement from spin-coater to DBD apparatus).

TABLE 3

| | | Molar ratio | C | O | N | C/O |
|---|---|---|---|---|---|---|
| # | | DMA:Bz | % | % | % | ratio |
| | EGDMA | 100:0 | 76.9 | 19.3 | 3.8 | 3.9 |
| | | | [71.4] | [28.6] | [0] | [2.5] |
| | PEGDMA | 100:0 | 72.8 | 26.2 | 1.0 | 2.8 |
| | | | [63.2] | [36.8] | [0] | [1.7] |
| | BzEGBz | 0:100 | 76.2 | 21.8 | 2.0 | 3.5 |
| | | | [77.3] | [18.2] | [4.5] | [4.2] |
| | BzPEGBz | 0:100 | 72.7 | 26.1 | 1.2 | 2.8 |
| | | | [75.5] | [20.8] | [3.8] | [3.6] |
| 1.2 | EGDMA/ | 83:16 | 76.1 | 21.4 | 2.5 | 3.6 |
| | BzEGBz | | [73.8] | [24.4] | [1.8] | [3.0] |
| 2.2 | EGDMA/ | 88:11 | 75.7 | 23.1 | 1.2 | 3.3 |
| | BzPEGBz | | [73.0] | [25.4] | [1.5] | [2.9] |
| 3.2 | PEGDMA/ | 62:37 | 72.9 | 25.9 | 1.2 | 2.8 |
| | BzEGBz | | [68.8] | [29.4] | [1.8] | [2.3] |
| 4.2 | PEGDMA- | 71:28 | 70.9 | 28.9 | 0.2 | 2.5 |
| | BzPEGBz | | [68.1] | [30.4] | [1.5] | [2.4] |

### Characteristics of the IPNs

The thermal characteristic of IPNs has been investigated by Thermo-Gravimetric Analysis TGA and all the results are listed in Table 4. The degradation temperatures Ta at 5% weight mass loss and the char yields at 800° C. of the IPNs according to examples 1.1-4.3 have been experimentally determined by TGA with a heating rate of 10° C. min⁻¹. The experimentally measured values are compared with calculated expected values based on components ratio forming the IPNs.

Comparison of those values reveals the improved thermal stability and char yield of IPNs frameworks based on EGDMA due to addition of Bz, evidencing synergism between networks. Moreover, the char yield increases with shortening of ethylene oxide backbone and increasing concentration of Bz.

TABLE 4

| | | | T_{d} [° C.] | | Char yield | |
|---|---|---|---|---|---|---|
| | | DMA/Bz | | theo- | | theo- |
| # | monomers | in wt | measured | retical | measured | retical |
| | BzEGBz | | 276.06 ± | — | 42.66 ± | — |
| | | | 14.08 | | 3.42 | |
| | BzPEGBz | | 314.83 ± | — | 29.75 ± | — |
| | | | 12.77 | | 1.19 | |
| 1.1 | EGDMA/ | 50/50 | 275.72 ± | 208.5 | 31.86 ± | 23.8 |
| | BzEGBz | | 6.92 | | 5.47 | |
| 1.2 | | 60/40 | 271.89 ± | 194.99 | 21.64 ± | 20.03 |
| | | | 6.67 | | 1.78 | |
| 1.3 | | 70/30 | 279.22 ± | 181.48 | 16.80 ± | 16.25 |
| | | | 8.83 | | 0.14 | |
| 2.1 | EGDMA/ | 50/50 | 302.11 ± | 227.89 | 16.43 ± | 17.34 |
| | BzPEGBz | | 5.23 | | 0.24 | |
| 2.2 | | 60/40 | 296.39 ± | 210.5 | 13.07 ± | 14.86 |
| | | | 3.56 | | 0.66 | |
| 2.3 | | 70/30 | 289.39 ± | 193.11 | 11.60 ± | 12.38 |
| | | | 3.13 | | 2.77 | |
| 3.1 | PEGDMA/ | 50/50 | 298.56 ± | 253.92 | 14.16 ± | 21.82 |
| | BzEGBz | | 2.84 | | 1.01 | |
| 3.2 | | 60/40 | 297.11 ± | 249.49 | 12.14 ± | 17.65 |
| | | | 0.67 | | 2.20 | |
| 3.3 | | 70/30 | 296.39 ± | 245.06 | 8.86 ± | 13.48 |
| | | | 2.41 | | 1.26 | |
| 4.1 | PEGDMA/ | 50/50 | 304.28 ± | 273.31 | 10.50 ± | 15.36 |
| | BzPEGBz | | 1.55 | | 1.32 | |
| 4.2 | | 60/40 | 296.72 ± | 265 | 8.22 ± | 12.49 |
| | | | 8.33 | | 1.55 | |
| 4.3 | | 70/30 | 296.94 ± | 256.69 | 5.28 ± | 9.61 |
| | | | 6.77 | | 0.77 | |
| | poly | | 140.94 ± | — | 4.94 ± | — |
| | EGDMA | | 15.06 | | 6.41 | |
| | poly | | 231.78 ± | — | 0.98 ± | — |
| | PEGDMA | | 11.91 | | 0.52 | |

### Influence on the Nano-Mechanical Properties

Amplitude Modulation-Frequency Modulation Atomic Force Microscopy (AM-FM AFM) viscoelastic studies were conducted on cross sections of the IPNs thin film coating. The surfaces for AFM analyses were prepared by embedding into a two component epoxy resin the coated silicon substrate to allow the cut of the cross section. The resulting surface was first polished with sand paper, followed by diamond polishing liquid to obtain very smooth surfaces. AFM imaging was carried out in a Cypher AFM (Asylum Research) operated in AM-FM-mode using silicon nitride tips.

The influence of the length of ethylene glycol backbone on the mechanical properties has been investigated by observing the Young modulus topographical distribution obtained by the above AFM analyses on the examples 1 to 4.

In example 1 where the monomers are EGDMA/BzEGBz, the respective lengths n1 and m1 of the ethylene glycol backbones are equal, i.e. n1=m1. In example 2 where the monomers are EGDMA/BzPEGBz, the length n1 of the ethylene glycol backbones in EGDMA is smaller than length m8 of the ethylene glycol backbones in BzPEGBz, i.e. n1<m8. In example 3, this is the contrary, i.e. n8>m1. In example 4, the respective lengths n8 and m8 of the ethylene glycol backbones are equal, i.e. n8=m8.

Within one concentration (i.e. one of 50/50, 60/40, 70/30), the nano-mechanical pattern show low-modulus cells decreasing in diameter with the ethylene glycol backbone length. Due to the concentration of branches within a scan, this pattern can be assigned to the BZ component.

The influence of the concentrations of monomers for given lengths of ethylene glycol backbone on the mechanical properties has been investigated by observing the Young modulus topographical distribution obtained by the above AFM analyses on the examples 1 to 4.

In example 1.1 where the respective lengths n1 and m1 of the ethylene glycol backbones are equal (n1=m1), histograms of the Young modulus topographic distribution are narrow, corresponding to an optimum chain interlacing and interpenetration of both phases. Dilution of the BZ monomers in DMA (examples 1.2 and 1.3) produces a broadening of the histograms, corresponding to a phase separation. In example 4.1, where the respective lengths of the ethylene glycol backbones are n8=m8, the histograms of the Young modulus topographic distribution are broad whereas for examples 4.3, they are narrow as in example 1.3. Examples 2 and 3, where the ethylene oxide backbone lengths are n1<m8 and n8>m1, respectively, exhibit broad histograms, shifted to lower Young modulus values with respective BZ dilution.

This indicates that the length of the ethylene glycol backbone of BZ affects the thickness of high modulus domains. Playing with ratio and length of ethylene glycol backbone of both components allows tuning IPNs properties to reach desirable nano-mechanical properties.

### Scratch Resistance

IPN samples were prepared by the so-called dynamic deposition method with the composition as in example 2.2 and 4.1. For comparison, a non-IPN sample prepared with the composition of 100% molar PEGDMA was prepared by the so-called dynamic deposition method but without the thermal curing step. The IPN samples showed an increase of scratch resistance up to 380% in comparison with the non-IPN sample.

1.-20. (canceled)

21. A process of producing an interpenetrated network of at least two polymers; comprising the following steps:
(a) preparing a mixture comprising a first monomer and a second monomer;
(b) applying the mixture on a substrate; and
(c) curing the first monomer and the second monomer so as to form the interpenetrated network;
wherein the first monomer is a vinyl or allyl monomer; the second monomer is a polymerizable cyclic monomer; and step (c) comprises using a plasma so as to first cure the first monomer; and
wherein plasma power values range is of from 0.1 to 150 W·cm⁻².

22. The process according to claim 21, wherein said mixture is free of a polymerisation initiator and/or reversible radical transfer agents.

23. The process according to claim 21, wherein the plasma is pulsed with a duty cycle t_{ON}/t_{ON}+t_{OFF}, where to is a duration of the plasma when active and t_{OFF} is a duration of the plasma when inactive, during each cycle, that is comprised between 10⁻⁴ and 10⁻² μs.

24. The process according to claim 21, wherein the plasma is pulsed and exhibits, for each cycle, an active duration t_{ON} that is not more than 0.2 ms and an inactive duration t_{OFF} that is more than 10 ms.

25. The process according to claim 21, wherein the plasma is at atmospheric pressure.

26. The process according to claim 21, wherein the plasma is a Dielectric Barrier Discharge plasma.

27. The process according to claim 21, wherein the first monomer comprises a telechelic monomer or oligomer, or at least one selected from the group consisting of acrylate derivatives, acrylic, styrenic or vinyl ether and macromonomer derivatives thereof, methacrylate (MA) derivative, preferably ethylene glycol dimethacrylate (EGDMA) and/or polyethylene glycol dimethacrylate (PEGDMA), methylacrylate, ethylacrylate, 2-chloroethylvinylether, 2-ethylhexylacrylate, hydroxyethylmethacrylate, butylacrylate, butylmethacrylate, TMPTA, allyl acrylate and allyl methacrylate, or mixture thereof.

28. The process according to claim 21, wherein the second monomer is benzoxazines derivatives, epoxide derivatives, cyclic acetals, lactams and cyclosiloxanes telechelic monomers or oligomers.

29. The process according to claim 21, wherein the second monomer is selected from the group consisting of a telechelic monomer of benzoxazine BZ and of ethylene glycol EG (BZ-EG-BZ) and a telechelic monomer of benzoxazine BZ and polyethylene glycol PEG (BZ-PEG-BZ).

30. The process according to claim 21, wherein, in the mixture of step (a), a ratio in weight between the first monomer and the second monomer is comprised between 80/20 and 40/60, preferably between 70/30 and 50/50.

31. The process according to claim 21, wherein, when the first monomer is associated with ethylene oxide backbone originating from EG and/or PEG, said ratio is of from 70/30 to 50/50.

32. The process according to claim 21, wherein in step (c) the plasma used for first curing the first monomer is followed by a thermal curing of the second monomer.

33. The process according to claim 32, wherein the thermal curing is achieved at a temperature comprised between 170° ° C. and 210° C.

34. The process according to claim 33, wherein the thermal curing has a duration of at least one hour.

35. The process according to claim 21, wherein steps (b) and (c) are performed iteratively in such a manner that the step (c) is limited to the plasma curing of the first monomer until obtaining a predetermined thickness of a corresponding layer, preferably from 10 nm to 5 μm, after that the thermal curing of the second monomer is carried out.

36. The process according to claim 21, wherein plasma used in step c) is continuous, delivered with an electrical signal in a continuous form.

37. A process of producing an interpenetrated network of at least two polymers; comprising the following steps:
(a) preparing a mixture comprising a first monomer and a second monomer;
(b) applying the mixture on a substrate; and
(c) curing the first monomer and the second monomer so as to form the interpenetrated network;
wherein the first monomer is a vinyl or allyl monomer; the second monomer is a polymerizable cyclic monomer; and step (c) comprises using a plasma so as to first cure the first monomer; and
wherein said mixture is free of a polymerisation initiator and/or reversible radical transfer agents.

38. An interpenetrated network of at least two polymers applied on a substrate, wherein the at least two polymers comprise a first polymer that is a vinyl or allyl polymer and a second polymer obtained through the curing of a polymerizable cyclic monomer.

39. The interpenetrated network according to claim 38, wherein the first polymer is derived from monomers comprising a telechelic monomer or oligomer, or at least one selected from the group consisting of acrylate derivatives, acrylic, styrenic or vinyl ether and macromonomer derivatives thereof, methacrylate (MA) derivative, preferably ethylene glycol dimethacrylate (EGDMA) and/or polyethylene glycol dimethacrylate (PEGDMA), methylacrylate, ethylacrylate, 2-chloroethylvinylether, 2-ethylhexylacrylate, hydroxyethylmethacrylate, butylacrylate, butylmethacrylate, TMPTA, allyl acrylate and allyl methacrylate, or mixture thereof.

40. The interpenetrated network according to claim 38, wherein the second polymer is a polymer of benzoxazine BZ and of ethylene glycol EG (BZ-EG-BZ) or a polymer of benzoxazine BZ and polyethylene glycol PEG (BZ-PEG-BZ).
